(19) United States
(12) Patent Application Publication
(10) Pub. No.: US 2012/0306637 A1
(43) Pub. Date: Dec. 6, 2012

(54) SYSTEM AND METHOD FOR SELECTIVELY ALTERING CONTENT OF A VEHICLE INTERFACE

(75) Inventors: Beth A. McGough, Holland, MI (US); Tony M. Lamb, Holland, MI (US)

(73) Assignee: Johnson Controls Technology Company, Holland, MI (US)

(21) Appl. No.: 13/150,604

(22) Filed: Jun. 1, 2011

(51) Int. Cl. B60Q 1/00

(52) U.S. Cl. 340/439; 340/438

(57) ABSTRACT

A vehicle interface is provided that includes a controller configured to selectively alter content presented by the vehicle interface in response to receiving a signal indicative of driver distraction.

### BACKGROUND

The invention relates generally to a system and method for selectively altering content of a vehicle interface.

Certain vehicles include a variety of displays configured to convey information to a driver. For example, an instrument panel may include gauges and/or displays configured to present information related to vehicle speed, fuel quantity, fuel efficiency, oil temperature, oil pressure, coolant temperature and engine speed, among other parameters. Certain instrument panels also include graphical representations of the displayed information. For example, the instrument panel may include a display configured to present a graph of fuel efficiency as a function of time. In addition, the vehicle may include another display within a center console configured to present further graphical information to the driver. For example, the center console display may present information related to navigation, environmental controls and audio functions, among other information. Unfortunately, the complexity of the graphical content presented by the displays may direct driver focus away from the vehicle surroundings.

### BRIEF DESCRIPTION OF THE INVENTION

The present invention relates to a vehicle interface including a controller configured to selectively alter content presented by the vehicle interface in response to receiving a signal indicative of driver distraction.

The present invention also relates to a vehicle interface including a graphical display, and a controller configured to present a first layout on the graphical display having a first level of content. The controller is also configured to present a second layout on the graphical display having a second level of content, less than the first level of content, in response to receiving a signal indicative of driver distraction.

The present invention further relates to a method of operating a vehicle interface including selectively altering content presented by the vehicle interface in response to receiving a signal indicative of driver distraction.

### DRAWINGS

FIG. 1 is a perspective view of an exemplary vehicle that may include an interface configured to selectively alter content in response to detected driver distraction.

FIG. 2 is a perspective view of a part of the interior of the vehicle of FIG. 1.

FIG. 3 is a block diagram of an embodiment of an interface that may be employed within the vehicle of FIG. 1.

FIG. 4 is a front view of an exemplary graphical display, presenting a first layout having a first content level.

FIG. 5 is a front view of the graphical display of FIG. 4, presenting a second layout having a second content level, less than the first content level.

FIG. 6 is a front view of an alternative graphical display, presenting a first layout having a first content level.

FIG. 7 is a front view of the graphical display of FIG. 6, presenting a second layout having a second content level, less than the first content level.

FIG. 8 is a flow diagram of an exemplary method of operating a vehicle interface.

### DETAILED DESCRIPTION

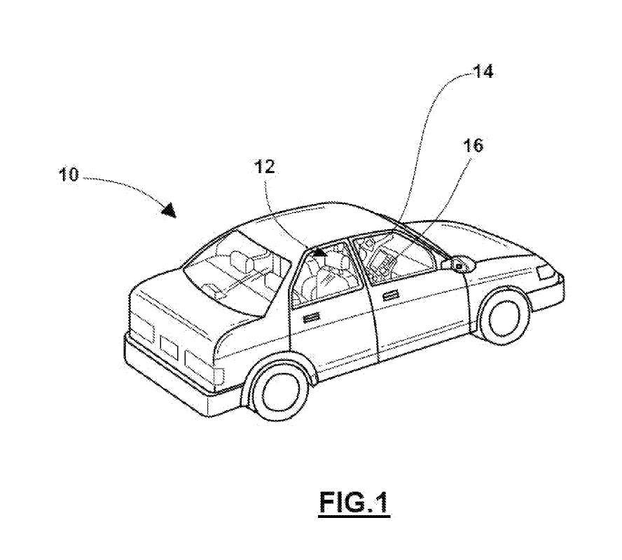

FIG. 1 is a perspective view of an exemplary vehicle 10 that may include an interface configured to selectively alter content in response to detected driver distraction. As illustrated, the vehicle 10 includes an interior 12 having an instrument panel 14 and a center console 16. As discussed in detail below, graphical displays within the instrument panel 14 and/or the center console 16 present graphical information to a driver regarding a variety of parameters associated with vehicle operation. Upon detection of driver distraction, a controller communicatively coupled to the graphical displays will alter content presented to the driver, thereby enabling the driver to focus on the vehicle surrounding (e.g., road conditions, approaching obstacles, etc.). For example, the controller may be configured to detect lane departure, an approaching object, driver eye closure, driver eye position, cell phone activation, erratic speed and/or interior noise level, for example. Once driver distraction is detected, the controller may remove elements of the graphical content and/or increase the font size of the textual content. As a result, information may be conveyed to the driver in a more concise/simplistic manner, thereby reducing driver focus on the displays and/or directing driver attention toward the vehicle surroundings. When the driver distraction is no longer detected, the controller may restore the content of the displays to the original level.

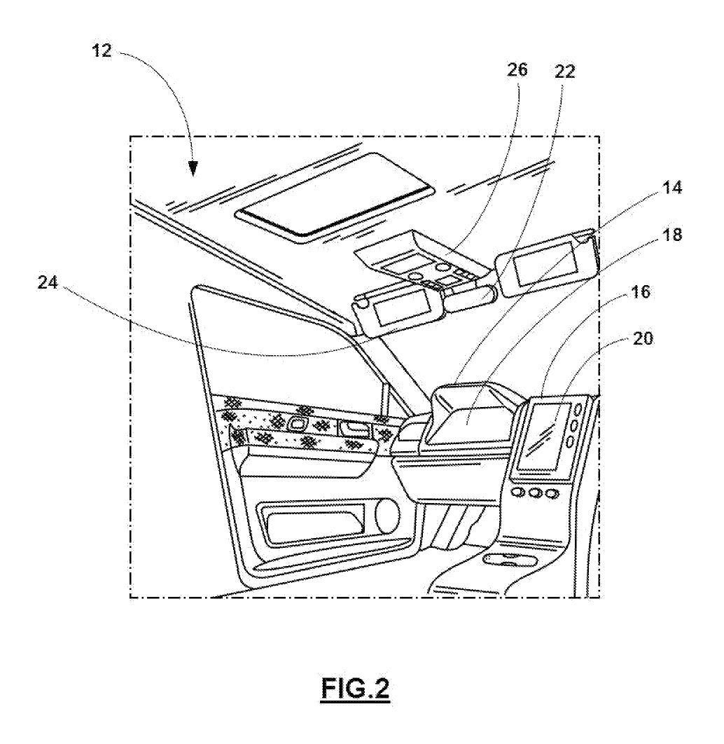

FIG. 2 is a perspective view of a part of the interior 12 of the vehicle 10 of FIG. 1. As illustrated, the instrument panel 14 includes a first graphical display 18, and the center console 16 includes a second graphical display 20. As discussed in detail below, each display 18 and 20 is configured to present graphical information associated with vehicle operation to the driver. Upon detection of driver distraction, a controller communicatively coupled to the displays will alter content presented to the driver, thereby enabling the driver to focus on road conditions. For example, the controller may be configured to remove graphical elements and/or increase the font size of the displayed content. In addition, the vehicle 10 may include a voice prompt configured to verbalize driving directions, traffic reports and/or text messages received by a cellular phone, for example. Similar to the graphical displays, the controller may be configured to alter content presented by the voice prompt (e.g., by providing shorter messages) in response to detection of driver distraction. While the illustrated interior 12 includes graphical displays within the instrument panel 14 and the center console 16, it should be appreciated that alternative embodiments may include graphical displays located within other components of the vehicle interior. For example, in certain embodiments, a graphical display may be disposed within a rearview minor 22, a sun visor 24 and/or an overhead console 26. Such embodiments may also include a controller communicatively coupled to each display, and configured to alter content presented by the display in response to detection of driver distraction.

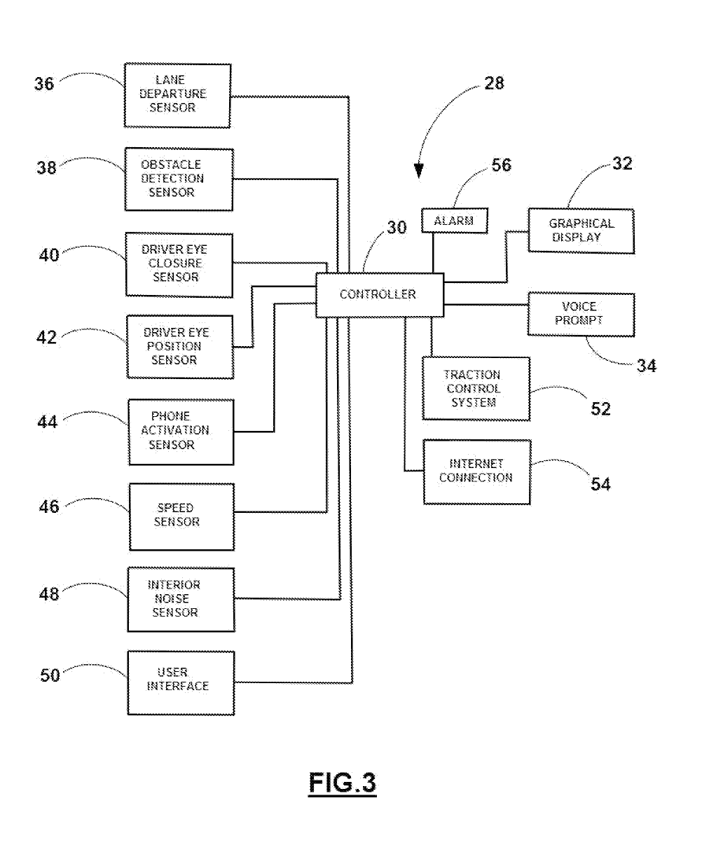

FIG. 3 is a block diagram of an embodiment of an interface 28 that may be employed within the vehicle 10 of FIG. 1. As illustrated, the interface 28 includes a controller 30 configured to selectively alter content presented by a graphical display 32. For example, the graphical display 32 may be an instrument panel display 18 or a center console display 20, as described above with reference to FIG. 2. In the illustrated embodiment, the controller 30 is configured to receive a signal indicative of driver distraction, and to alter content presented by the graphical display 32 in response to receiving the signal. For example, the controller 30 may be configured to remove graphical elements and/or increase the font size of the displayed content. In certain embodiments, the display 32 may include a graph configured to present a value of a parameter (e.g., vehicle speed, fuel economy, coolant temperature, etc.) as a function of time. In such embodiments, the controller 30 may be configured to remove the graph and provide a numerical representation of an instantaneous value of the parameter in response to receiving a signal indicative of driver distraction. Consequently, the driver may identify the value more quickly, thereby enabling the driver to focus on the vehicle surroundings.

In further embodiments, the controller 30 may remove a numerical representation of a vehicle parameter and provide a symbol indicating whether the parameter is within a desired range in response to receiving a signal indicative of driver distraction. For example, the display 32 may present a numerical representation of coolant temperature, oil pressure, oil temperature and battery voltage. If driver distraction is detected, the controller 30 may remove the numerical representations and provide an icon indicating whether each parameter is within a desired range. For example, if the coolant temperature, oil pressure, oil temperature and battery voltage are within the desired range, the controller 30 may present respective green icons. However, if any parameter is outside of the desired range, the controller 30 may change the icon color to red, thereby alerting the driver to the detected condition. In further embodiments, the controller 30 may only present the icon if the parameter is outside of the detected range. In this configuration, the driver may identify the state of vehicle parameters more rapidly, thereby enabling the driver to focus on the vehicle surroundings.

In certain embodiments, the graphical display 32 may be configured to present only textual content to the driver. For example, the interface 28 may include a two-line dot matrix display configured to present static textual messages and/or scrolling textual messages. In such embodiments, the controller 30 is configured to alter content presented by the dot matrix display in response to receiving a signal indicative of driver distraction. By way of example, the dot matrix display may present information received from the Radio Broadcast Data System (RBDS), such as the artist and title of a song. If the number of characters in the title of the song is greater than the maximum number of displayable characters, the dot matrix display may scroll the text of the title to present the entire content to the driver. However, if the controller 30 detects that the driver is distracted (e.g., driver focus is directed toward the display for an excessive duration), the scrolling action may be paused, thereby directing driver focus toward the vehicle surroundings.

In further embodiments, the graphical display 32 may be a head-up display (HUD) configured to project content onto a windshield and/or other surfaces of the vehicle 10. In such embodiments, the controller 30 is configured to alter content presented by the HUD in response to receiving a signal indicative of driver distraction. For example, the controller 30 may be configured to remove graphical elements and/or increase the font size of the displayed content. In certain embodiments, the HUD may include a graph configured to present a value of a parameter (e.g., vehicle speed, fuel economy, coolant temperature, etc.) as a function of time. In such embodiments, the controller 30 may be configured to remove the graph and provide a numerical representation of an instantaneous value of the parameter in response to receiving a signal indicative of driver distraction. Consequently, the driver may identify the value more quickly, thereby enabling the driver to focus on the vehicle surroundings. Alternatively, the controller 30 may be configured to deactivate the HUD in response to receiving a signal indicative of driver distraction, thereby further enhancing driver focus on the vehicle surroundings.

In addition, the interface 28 includes a voice prompt 34 communicatively coupled to the controller 30. Similar to the graphical display 32, the controller 30 is configured to alter content presented by the voice prompt 34 in response to receiving a signal indicative of driver distraction. For example, the voice prompt 34 may be configured to verbalize text messages received by a cellular phone. In such an embodiment, if the controller 30 detects that the driver is distracted, the voice prompt may only indicate that a text message has been received, instead of verbalizing the entire message. The shortened verbal response may enhance driver focus on the vehicle surroundings, thereby reducing driver distraction. As will be appreciated, additional verbal messages (e.g., driving directions, traffic reports, etc.) provided by the voice prompt 34 may be shortened to facilitate enhanced driver focus if a signal indicative of driver distraction is detected.

In the illustrated embodiment, a variety of sensors are communicatively coupled to the controller 30 to facilitate detection of driver distraction. Specifically, the illustrated vehicle interface 28 includes a lane departure sensor 36, an obstacle detection sensor 38, a driver eye closure sensor 40, a driver eye position sensor 42, a phone activation sensor 44, a speed sensor 46, and an interior noise sensor 48. The lane departure sensor 36 is configured to detect movement of the vehicle 10 outside of a designated lane. For example, the lane departure sensor 36 may include a camera configured to monitor the position of the vehicle 10 relative to left and right lane markings. If the vehicle 10 crosses one of the lane markings, the lane departure sensor 36 will send a signal to the controller 30 indicative of driver distraction. By way of example, if the driver is focused on the graphical display 32, the vehicle may inadvertently drift outside of the designated lane. Upon detection of lane departure, the controller 30 will alter content presented by the graphical display 32 (e.g., via reducing a level of content), thereby enabling the driver to focus on the vehicle surroundings. Once the vehicle has returned to the designated lane, the controller 30 will restore the original content presented by the display 32.

Similarly, the obstacle detection sensor 38 is configured to detect an object proximate to the vehicle 10. For example, the obstacle detection sensor 38 may include ultrasonic transducers, capacitance sensors, induction sensors, optical transducers and/or radio frequency transducers, among other sensors, configured to identify the position and/or velocity of an object relative to the vehicle 10. By way of example, if the driver is focused on the graphical display 32 during a backing maneuver, the vehicle may inadvertently approach a stationary object. Upon detection of the approaching object, the controller 30 will alter content presented by the graphical display 32 (e.g., via reducing a level of content), thereby enabling the driver to focus on the vehicle surroundings.

Furthermore, the driver eye closure sensor 40 is configured to monitor the position of driver eyelids via an optical and/or infrared sensor, for example. In certain embodiments, the eye closure sensor 40 may be configured to determine the percentage of eye closure. For example, an eye closure of 80% may be indicative of driver fatigue. Consequently, if the eye closure sensor 40 detects significant eye closure (e.g., greater than 80%), the sensor will send a signal to the controller 30 indicative of driver distraction. In addition, the eye closure sensor 40 may be configured to detect a high blink rate and/or long duration blinks, which may be associated with driver fatigue. If a high blink rate and/or long duration blinks are detected, the sensor will send a signal to the controller 30 indicative of driver distraction. If the controller 30 receives a signal indicative of driver distraction from the driver eye closure sensor 40, the controller 30 will alter content presented by the graphical display 32 (e.g., via reducing a level of content), thereby enabling the driver to focus on the vehicle surroundings.

Similarly, the driver eye position sensor 42 is configured to determine the orientation of the driver pupil relative to the vehicle interior 12 via an optical and/or infrared sensor, for example. Consequently, the sensor 42 will determine whether the driver is looking through the vehicle windshield or at the graphical display 32. If the driver is focused on the graphical display 32, or other component within the vehicle interior 12, for an excessive duration, the eye position sensor 42 will send a signal to the controller 30 indicative of driver distraction. If the controller 30 receives a signal indicative of driver distraction from the driver eye position sensor 42, the controller 30 will alter content presented by the graphical display 32 (e.g., via reducing a level of content), thereby prompting the driver to focus on the vehicle surroundings.

In addition, the driver eye position sensor 42 may be configured to determine cognitive load by measuring pupil dilation. For example, if the driver is performing a visual perception task, such as monitoring high density traffic, the pupils may dilate slightly (e.g., by 0.5 mm) If such pupil dilation is detected, the driver eye position sensor 42 will send a signal to the controller 30 indicative of driver distraction. The controller 30 will then alter content presented by the graphical display 32, thereby allowing the driver to focus on the cognitive task.

In addition, the phone activation sensor 44 is configured to detect operation of a phone within the vehicle interior 12. For example, the vehicle 10 may be configured to interface with a phone via a Bluetooth connection. In such an embodiment, the phone activation sensor 44 will detect operation of the phone, and send a signal to the controller 30 upon phone activation. The controller 30 will then alter content presented by the graphical display 32 (e.g., via reducing a level of content). For example, providing reduced content during periods of phone activation may enable the driver to maintain focus on the vehicle surroundings.

Furthermore, the speed sensor 46 is configured to detect erratic and/or excessive vehicle speeds. As will be appreciated, erratic vehicle speed may be indicative of driver distraction and/or high traffic density. In addition, it may be beneficial to direct driver attention to the vehicle surrounds when the vehicle is operating at high speeds. For example, in certain embodiments, the interface 28 may be communicatively coupled to a spatial locating device, such as a global positioning system (GPS), configured to determine the posted speed limit at the current vehicle location. In such embodiments, the controller 30 will identify excessive speeds if the current vehicle speed exceeds the posted speed limit by a threshold value (e.g., 5, 10, 15 miles per hour, or more). The controller 30 will then alter content presented by the graphical display 32 (e.g., via reducing a level of content) upon receiving a signal indicative of erratic and/or excessive vehicle speeds, thereby directing driver focus toward the vehicle surroundings.

The interior noise sensor 48 is configured to monitor the noise level within the vehicle interior. If the noise level exceeds a threshold volume (e.g., due to music, occupants, etc.), the sensor 46 will output a signal indicative of driver distraction to the controller 30. The controller 30, in turn, will alter content presented by the graphical display 32 (e.g., via reducing a level of content) to facilitate driver focus on the vehicle surroundings. While the illustrated vehicle interface 28 includes a lane departure sensor 36, an obstacle detection sensor 38, a driver eye closure sensor 40, a driver eye position sensor 42, a phone activation sensor 44, a speed sensor 46, and an interior noise sensor 48, it should be appreciated that alternative embodiments may include more or fewer sensors configured to detect driver distraction. For example, further embodiments may include a driver head position sensor configured to determine if driver attention is directed toward the vehicle interior for an excessive duration. Other embodiments may include a heart rate monitor configured to send a signal indicative of driver distraction if the driver heart rate exceeds a threshold value. The interface 28 may also include an accelerometer and/or a steering wheel position sensor, among other sensors, configured to detect driver distraction.

In the illustrated embodiment, the vehicle interface 28 includes a user interface 50 configured to selectively alter content presented by the graphical display 32 and/or the voice prompt 34. For example, a driver may elect to increase the font size of textural information presented by the graphical display 32 to enhance identification of vehicle parameters. In addition, a vehicle owner may lock the interface 28 into a reduced content mode for student drivers. For example, a parent may use the user interface 50 to lock the vehicle interface 28 into the reduced content mode before allowing a student driver to operate the vehicle 10. In such an embodiment, access to the user interface may be password protected, thereby preventing the student driver from increasing the level of content.

In the illustrated embodiment, the vehicle interface 28 is communicatively coupled to a traction control system 52. As will be appreciated, the traction control system 52 is configured to substantially reduce wheel spin during acceleration and/or steering maneuvers. If the traction control system 52 is activated (e.g., while the vehicle is traveling along a slippery road), the traction control system will send a signal to the controller 30 indicative of driver distraction. The controller 30, in turn, will alter content presented by the graphical display 32 and/or the voice prompt 34, thereby enabling the driver to focus on the reduced traction condition. Furthermore, the illustrated controller 30 is communicatively coupled to an internet connection 54. In certain embodiments, the internet connection 54 is configured to determine weather conditions and/or traffic density at the current vehicle location. If inclement weather and/or a high traffic density is detected, the controller 30 may alter content to facilitate driver focus on the detected traffic and/or weather conditions.

In the illustrated embodiment, an alarm 56 is also communicatively coupled to the controller 30. The controller 30 is configured to activate the alarm 56 in response to receiving the signal indicative of driver distraction. In certain embodiments, the alarm may be an audible alarm and/or a visual alarm. For example, if the controller 30 detects that the driver is distracted (e.g., via one of the sensors), the controller 30 will activate the alarm 56 to focus driver attention on the vehicle surroundings. By way of example, if the driver eye position sensor 42 determines that the driver is looking at the graphical display 32 for an excessive duration, the controller 30 will activate the alarm 56 and reduce the level of content presented by the graphical display 32. Consequently, the driver will be prompted to look at the roadway, while being presented with less content on the display 32.

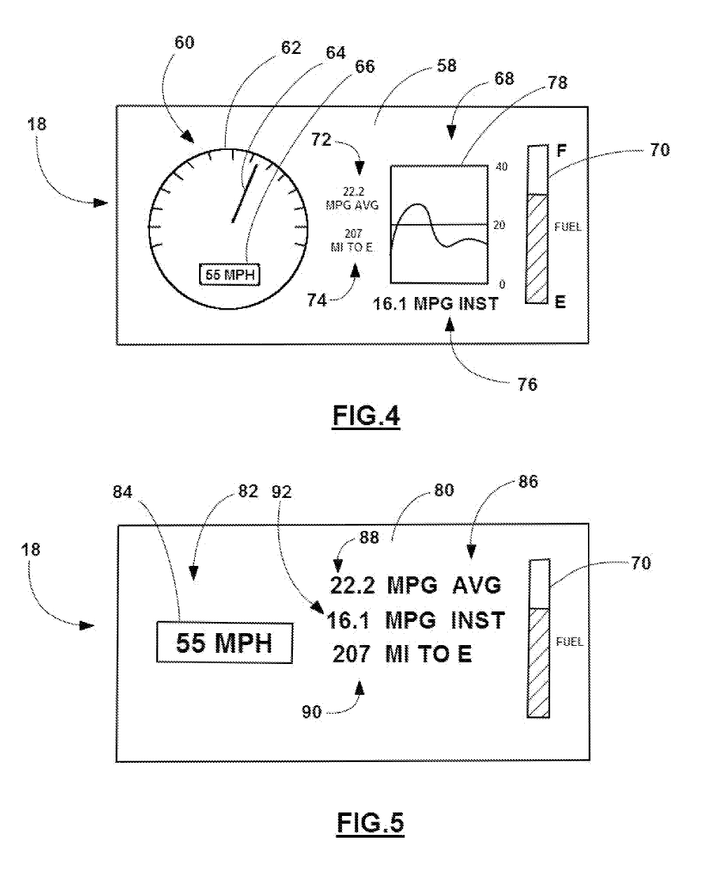

FIG. 4 is a front view of an exemplary graphical display, presenting a first layout having a first content level. In the illustrated embodiment, the graphical display represents an instrument panel display 18 configured to present vehicle operating information to a driver. As illustrated, the instrument panel display 18 includes a first layout 58 having various graphical elements. Specifically, the display 18 includes a graphical representation of a speedometer 60 configured to graphically represent vehicle speed. As illustrated, the speedometer 60 includes a gauge 62 and an indicator 64 configured to represent vehicle speed in a manner similar to an electromechanical gauge. The speedometer 60 also includes a digital readout 66 configured to present a numerical representation of vehicle speed. Such a speedometer configuration will effectively present vehicle speed information to a driver, while providing a desirable appearance.

The first layout 58 also includes a fuel information section 68 having a variety of graphical and numerical representations of fuel quantity and usage information. As illustrated, the fuel information section 68 includes a fuel gauge 70 configured to graphically represent available fuel quantity. In addition, the fuel information section 68 includes a first digital readout 72 configured to present a numerical representation of average fuel efficiency in miles per gallon (MPG AVG), a second digital readout 74 configured to present anticipated range in miles (MI TO E), and a third digital readout 76 configured to present a numerical representation of instantaneous fuel efficiency (MPG INST). The fuel information section 68 also includes a graph 78 representative of fuel efficiency as a function of time. The graph 78 may enable a driver to visually associate driving habits with fuel economy, thereby facilitating enhanced fuel efficiency. The illustrated fuel information section 68 effectively presents vehicle fuel quantity and usage information to a driver, while providing a desirable appearance.

FIG. 5 is a front view of the graphical display of FIG. 4, presenting a second layout having a second content level, less than the first content level. For example, if the controller receives a signal indicative of driver distraction, the controller will alter content presented by the display. In the illustrated embodiment, the instrument panel display 18 will present a second layout 80 having less content than the first layout 58. As a result, information will be conveyed to the driver more quickly, thereby enabling the driver to focus on the vehicle surroundings (e.g., road conditions, approaching obstacles, vehicular traffic, etc.). In the illustrated embodiment, graphical elements of the content have been removed and the font size of display text has been increased in response to detected driver distraction. Specifically, the second layout 80 includes an alternative speedometer 82 having a digital readout 84 configured to present a numerical representation of vehicle speed. As illustrated, the font size of the digital readout 84 is larger than the font size of the digital readout 66 in the first layout 58. In addition, the gauge 62 and indicator 64 have been omitted. Consequently, the driver may be able to determine vehicle speed more quickly, thereby enabling the driver to focus on the vehicle surroundings.

In addition, the second layout 80 includes a simplified fuel information section 86. As illustrated, the graph 78 of the first layout 58 has been omitted, and the font size of the digital readouts has been increased. Specifically, the fuel information section 86 includes a first digital readout 88 configured to present a numerical representation of average fuel efficiency in miles per gallon (MPG AVG), a second digital readout 90 configured to present anticipated range in miles (MI TO E), and a third digital readout 92 configured to present a numerical representation of instantaneous fuel efficiency (MPG INST). Because the font size of each digital readout has been increased, the presented values may be identified more rapidly, thereby enabling the driver to focus on road conditions. However, it should be noted that the second layout 80 presents the same information to the driver as the first layout 58. Specifically, the second layout 80 includes values indicative of vehicle speed, average efficiency, instantaneous fuel efficiency and anticipated range. However, with the graphical elements removed, the information is presented in a more concise/simplified manner, thereby enabling the driver to read the displays in less time.

While vehicle speed and fuel information are included in the illustrated instrument panel display, it should be appreciated that alternative displays may include more or fewer graphical and/or textual elements. For example, certain displays may include graphical and/or numerical representations of engine rotation rate, coolant temperature, oil temperature, oil pressure, battery voltage and/or other parameters associated with vehicle operation. In such embodiments, the controller may be configured to reduce the level of content presented on the display to facilitate driver focus on the vehicle surroundings.

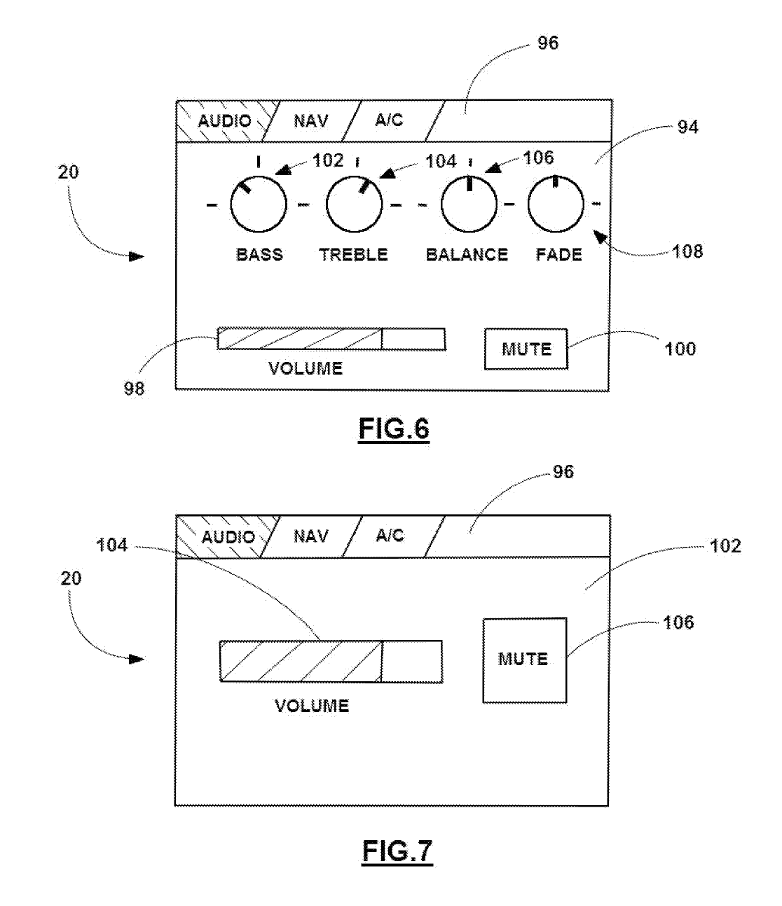

FIG. 6 is a front view of an alternative graphical display, presenting a first layout having a first content level. In the illustrated embodiment, the graphical display represents a center console display 20 configured to present audio functions, navigation information, and environmental controls to a driver. As illustrated, the center console display 20 includes a first layout 94 having various graphical elements. Specifically, the display 20 includes a menu bar configured to facilitate selection of an audio control screen (AUDIO), a navigation control screen (NAV), and an environmental control screen (A/C). As illustrated, the audio control screen is currently selected, thereby displaying graphical elements related to audio control features. In the illustrated embodiment, the first layout 94 includes a graphical volume indicator 98, a mute indicator 100, a graphical representation of a bass adjustment knob 102, a graphical representation of a treble adjustment knob 104, a graphical representation of a balance adjustment knob 106, and a graphical representation of a fade adjustment knob 108. In certain embodiments, the center console display 20 may include a touch screen interface, thereby enabling the driver to adjust the audio controls via the graphical elements of the display. Such an audio control arrangement will effectively present audio configuration information to a driver, while providing a desirable appearance.

FIG. 7 is a front view of the graphical display of FIG. 6, presenting a second layout having a second content level, less than the first content level. For example, if the controller receives a signal indicative of driver distraction, the controller will alter content presented by the display. In the illustrated embodiment, the center console display 20 will present a second layout 102 having less content than the first layout 94. As a result, information will be conveyed to the driver more quickly, thereby enabling the driver to focus on the vehicle surroundings (e.g., road conditions, approaching obstacles, vehicular traffic, etc.). In the illustrated embodiment, the graphical representations of the bass knob, treble knob, balance knob and fade knob have been omitted. In addition, the size of the volume indicator 104 and the mute indicator 106 have been increased. Consequently, the driver may be able to determine the volume level more quickly, thereby enabling the driver to focus on the vehicle surroundings. In addition, in embodiments having a touch screen interface, the larger indicators 104 and 106 may enable the driver to adjust the volume and/or mute the audio system more rapidly, thereby facilitating increased driver concentration on the vehicle surroundings.

While an audio control screen is described above, it should be appreciated that the controller may be configured to alter content presented on a navigation control screen, an environmental control screen and/or other screens available on the center console display in response to detected driver distraction. Furthermore, it should be appreciated that other graphical indicators/controls (e.g., graphic equalizer, audio mode selector, speed sensitive volume control, etc.) may be included on the audio control screen in alternative embodiments. In addition, it should be appreciated that additional displays may be located throughout the vehicle interior. In such embodiments, the controller may be communicatively coupled to each display and configured to alter content presented on the display in response to detected driver distraction.

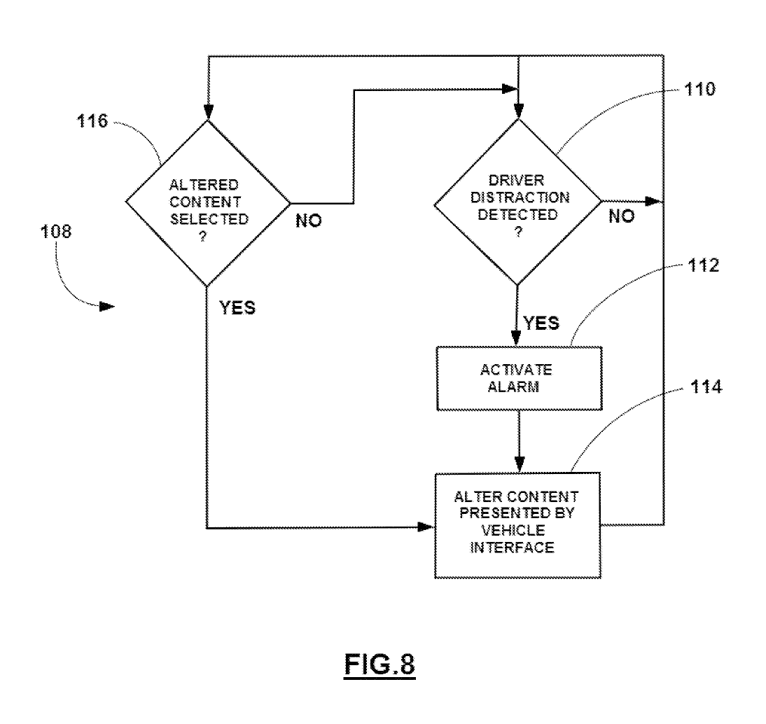

FIG. 8 is a flow diagram of an exemplary method 108 of operating a vehicle interface. First as represented by block 110, signals from a variety of sensors are monitored to detect driver distraction. For example, a controller may monitor signals from a lane departure sensor, an obstacle detection sensor, a driver eye closure sensor, a driver eye position sensor, a phone activation sensor and/or an interior noise sensor to determine whether the driver is distracted. If driver distraction is detected, an alarm will activate, as represented by block 112. As previously discussed, the alarm may be an audible and/or visual alarm configured to direct driver focus to the vehicle surroundings. In addition, if driver distraction is detected, content presented by the vehicle interface will be altered, as represented by block 114. For example, graphical elements of displayed content may be removed and/or voice prompts may be shortened, thereby enabling the driver to identify the value of parameters more quickly. Furthermore, content presented by the vehicle interface will be altered if an altered content is selected (e.g., via a user interface), as represented by block 116. For example, a parent may lock the vehicle interface into a reduced content mode before allowing a child to operate the vehicle.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A vehicle interface, comprising:
a controller configured to selectively alter content presented by the vehicle interface in response to receiving a signal indicative of driver distraction.

2. The vehicle interface of claim 1, wherein the vehicle interface comprises a graphical display.

3. The vehicle interface of claim 2, wherein the controller is configured to increase a font size of textual content presented by the graphical display in response to receiving the signal indicative of driver distraction.

4. The vehicle interface of claim 2, wherein the controller is configured to reduce a level of content presented by the graphical display via removal of graphical elements of the content.

5. The vehicle interface of claim 1, wherein the vehicle interface comprises a voice prompt.

6. The vehicle interface of claim 1, wherein the signal indicative of driver distraction comprises at least one of a signal indicative of lane departure, a signal indicative of obstacle detection, a signal indicative of driver eye closure, a signal indicative of driver eye position, a signal indicative of phone activation, a signal indicative of erratic speed, and a signal indicative of excessive interior noise.

7. The vehicle interface of claim 1, wherein the controller is configured to selectively alter content presented by the vehicle interface in response to user input.

8. The vehicle interface of claim 7, wherein the controller is configured to maintain a reduced level of content until a password is provided.

9. The vehicle interface of claim 1, wherein the controller is configured to selectively alter content presented by the vehicle interface in response to a signal indicative of inclement weather, reduced vehicle traction, or a combination thereof.

10. The vehicle interface of claim 1, wherein the controller is configured to restore content presented by the vehicle interface in response to termination of the signal.

11. A vehicle interface, comprising:
a graphical display; and
a controller configured to present a first layout on the graphical display having a first level of content, and to present a second layout on the graphical display having a second level of content, less than the first level of content, in response to receiving a signal indicative of driver distraction.

12. The vehicle interface of claim 11, wherein the controller is configured to present the first layout on the graphical display in response to termination of the signal.

13. The vehicle interface of claim 11, wherein the signal indicative of driver distraction comprises at least one of a signal indicative of lane departure, a signal indicative of obstacle detection, a signal indicative of driver eye closure, a signal indicative of driver eye position, a signal indicative of phone activation, a signal indicative of erratic speed, and a signal indicative of excessive interior noise.

14. The vehicle interface of claim 11, comprising a voice prompt, wherein the controller is configured to selectively reduce a level of content of the voice prompt in response to receiving the signal indicative of driver distraction.

15. The vehicle interface of claim 11, wherein the controller is configured to present the second layout on the graphical display in response to user input.

16. A method of operating a vehicle interface, comprising:
selectively altering content presented by the vehicle interface in response to receiving a signal indicative of driver distraction.

17. The method of claim 16, comprising activating an alarm in response to receiving the signal indicative of driver distraction.

18. The method of claim 16, comprising selectively altering content presented by the vehicle interface in response to user input.

19. The method of claim 16, comprising restoring content presented by the vehicle interface in response to termination of the signal.

20. The method of claim 16, wherein selectively altering content presented by the vehicle interface comprises at least one of reducing a level of content presented by a graphical display via removal of graphical elements of the content, and reducing the level of content of a voice prompt.
